(19) United States
(12) Patent Application Publication
(10) Pub. No.: US 2025/0319341 A1
(43) Pub. Date: Oct. 16, 2025

(54) POLYETHYLENE (PEI) FOAM ENHANCERS FOR FIREFIGHTING FOAM COMPOSITIONS FOR CLASS A AND CLASS B FIRES

(71) Applicant: PERIMETER SOLUTIONS LP, Clayton, MO (US)

(72) Inventors: Leilei ZHANG, Green Bay, WI (US); Carlson SUGIARTO, Green Bay, WI (US)

(21) Appl. No.: 19/172,882

(22) Filed: Apr. 8, 2025

Related U.S. Application Data
(60) Provisional application No. 63/634,061, filed on Apr. 15, 2024.

(51) Int. Cl. A62D 1/02

(52) U.S. Cl. CPC A62D 1/0071

(57) ABSTRACT

The present invention is generally directed to firefighting foam compositions containing a (modified or unmodified) polyethylene (PEI) polymer foam enhancer, including concentrates, solutions (e.g., foam-forming solutions), and the foams produced from the concentrates and/or solutions. Compositions of the present invention are typically fluorine-free. Compositions of the present invention are suitable for use for both Class A and Class B fires (Class A/B).

### REFERENCE TO RELATED APPLICATIONS

This application claims the benefit of, and priority to, U.S. Provisional Patent Application Ser. No. 63/634,061, filed Apr. 15, 2024, the entire contents of which are hereby incorporated by reference for all relevant purposes as if fully set forth herein.

### FIELD OF THE INVENTION

The present invention is generally directed to firefighting foam compositions containing a (modified or unmodified) polyethylene (PEI) polymer foam enhancer, including concentrates, solutions (e.g., foam-forming solutions), and the foams produced from the concentrates and/or solutions. Compositions of the present invention are typically fluorine-free. Compositions of the present invention are suitable for use for both Class A and Class B fires (Class A/B).

### BACKGROUND OF THE INVENTION

Aqueous firefighting foams may be used for fighting Class A fires involving combustible materials including, for example, paper and wood. Aqueous firefighting foams are also used against Class B fires fueled by flammable liquids such as, for example, liquid fuels (e.g., jet fuel), gasoline and other hydrocarbons. Such firefighting foams include both aqueous film-forming foams (AFFF) and alcohol-resistant aqueous film-forming foams (AR-AFFF).

Previously, conventional AFFF and AR-AFFF foams contained fluorine. However, due to toxicity, bioaccumulation, and persistence concerns, in recent years fluorine-free aqueous firefighting foams have been developed. Suitable fluorine-free foams have been developed that overcome many if not all these issues and concerns identified with fluorine-containing foams. However, areas of improvement exist for such foams.

Suitable fluorine free firefighting foam compositions are known. However, foams exhibiting further improvements to such foams would be desired for use against both Class A fires and Class B fires. Accordingly, there are areas and opportunities for improvement in connection with Class A firefighting foam compositions, Class B firefighting foam compositions, and Class A/B firefighting foam compositions.

### BRIEF SUMMARY OF THE INVENTION

Briefly, therefore, the present invention is directed to (fluorine-free) firefighting foam compositions (e.g., foam concentrates, foam forming solutions, and foams) comprising a modified or unmodified polyethylene (PEI) polymer foam enhancer (PEI foam enhancer).

Other objects and features will be in part apparent and in part pointed out hereinafter.

### BRIEF DESCRIPTION OF THE FIGURES

FIG. 1 provides foam expansion ratio and quarter drain time (QDT) results for testing described in Example 1.

FIG. 2 provides results for the effect of PEI concentration on foam expansion for testing described in Example 2.

FIG. 3 provides for the effect of PEI concentration on QDT for testing described in Example 2.

FIG. 4 provides results for foam expansion ratio testing described in Example 3.

FIG. 5 provides results for QDT testing described in Example 3.

### DETAILED DESCRIPTION OF THE INVENTION

Described herein are firefighting foam compositions, e.g., foam concentrates, foam forming solutions, and foams suitable for use in a variety of environments, including in connection with both Class A and Class B fires, including a PEI foam enhancer.

Firefighting foam compositions suitable for use in connection with PEI foam enhancers include those generally known in the art. Use of a PEI foam enhancer as described herein is currently believed to provide improvements in foam performance, for example, in terms of improved foam expansion (ratio) and quarter drain time (QDT).

The PEI foam enhancer may be incorporated in a firefighting foam concentrate in accordance with the present invention. The PEI foam enhancer may also be incorporated along with a firefighting foam concentrate and water for dilution to form a foam forming solution, or premix. Thus, certain embodiments of the present invention are directed to methods for preparing a firefighting foam premix or foam-forming solution comprising combining a firefighting foam concentrate, water, a PEI foam enhancer in accordance with the present invention, and optionally one or more other components.

For example, in certain embodiments, use of the PEI foam enhancer may provide improvements in foam expansion ratio of greater than one unit (e.g., 7.5 vs 6.5) for a foam composition containing a PEI foam enhancer as compared to an otherwise identical foam composition not containing the PEI foam enhancer. In certain embodiments, an improvement in foam expansion ratio of greater than about 2, greater than about 3, greater than about 4, greater than about 5, greater than about 6, greater than about 7, greater than about 8, greater than about 9, or greater than about 10. Typical improvements in foam expansion are at or above one of the above limits or values and less than about 20, less than about 15, or less than about 10.

Improvements in quarter drain time (QDT) for compositions of the present invention including a PEI foam enhancer as compared to an otherwise identical foam composition not containing the PEI foam enhancer may be at least about 1 minute, at least about 2 minutes, at least about 3 minutes, at least about 4 minutes, at least about 5 minutes, at least about 6 minutes, at least about 7 minutes, at least about 8 minutes, at least about 9 minutes, at least about 10 minutes, or even at least about 12 minutes, or at least about 15 minutes. Typical improvements in QDT are at or above one of the above limits or values and less than about 20 minutes, less than about 15 minutes, or less than about 10 minutes.

Additionally, or alternatively, improvements in QDT of at least about 5%, at least about 10%, at least about 15%, at least about 20%, or even at least about 25% are provided by incorporating a modified PEI foam enhancer of the present invention.

The PEI foam enhancers incorporated in accordance with the present invention are cationic molecules. Accordingly, various aspects of the present invention involve incorporating a cationic foam enhancer. Various embodiments discussed herein include firefighting compositions that are zwitterionic or anionic in nature (e.g., compositions described in the EMBODIMENTS section set forth below). Thus, various aspects of the present invention involve incorporating a cationic foam enhancer (e.g., a PEI foam enhancer described herein) to enhance the performance of a zwitterionic or anionic firefighting foam composition. Compositions of the present invention therefore include cationic foam enhancer-containing firefighting foam compositions.

### PEI Foam Enhancers

Generally, the PEI foam enhancers utilized in accordance with the present invention include a polyethylene polymer including ethyleneimine as shown below where the value for n (i.e., the number of ethyleneimine units) and molecular weight may vary widely. The polyethylene polymer may be linear or branched, as shown below, in structures (I) and (II), respectively. When branched, the PEI polymer may include secondary and/or tertiary amines.

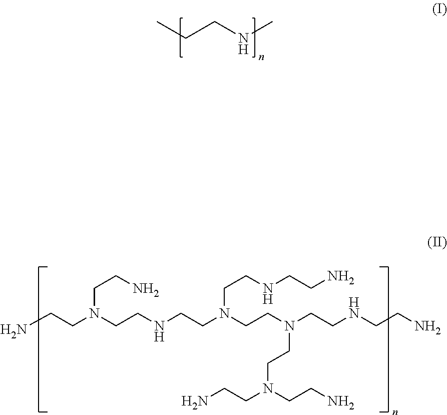

Generally, n may be from about 5 to about 1250, from about 50 to about 1000, or from about 75 to about 800.

PEI foam enhancers may be represented by the following:

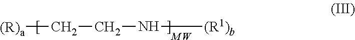

where the polyethyleneimine polymer (as represented by —[—CH₂—CH₂—NH—]_{MW}—) is linear or branched. Typically, the PEI polymer has a molecular weight (MW) of from about 0.2 kilodaltons (kDa) to about 800 kDa, from about 0.2 to about 100 kDa, from about 0.2 to about 30 kDa, or from about 0.2 to about 25 kDa. Various embodiments include a PEI polymer having a molecular weight in the range of from about 0.8 kDa to about 30 kDa (e.g., from about 0.8 kDa to about 25 kDa) or from about 2 kDa to about 30 kDa.

R and R¹ may be independently selected from H, hydrocarbyl, and substituted hydrocarbyl groups.

In various embodiments, R and R¹ are independently selected from substituted or unsubstituted, linear or straight chain alkyl groups and substituted or unsubstituted, linear or straight chain alkylene groups.

Suitable alkyl groups include C1-C10 alkyl groups, C2-C8 alkyl groups, C2-C6 alkyl groups, and C2-C4 alkyl groups.

Suitable alkylene groups include C1-C10 alkylene groups, C2-C8 alkylene groups, C2-C6 alkylene groups, and C2-C4 alkylene groups.

In certain embodiments, R and R¹ are independently selected from phenol groups, benzyl groups, and H.

Typically, the sum of a and b is from about 1 to about 50, from about 5 to about 45, or from about 10 to about 30 (e.g., from about 10 to about 20 or from about 20 to about 30). In accordance with various embodiments, R or R¹ is H and the total sum of a and b is constituted by either R or R¹.

In various embodiments, R and R¹ are independently selected from ethylene oxide (EO), polyethylene oxide (PEO), and propylene oxide (PO). In certain embodiments, R and R¹ are independently ethylene oxide. In other embodiments, R and R¹ are independently propylene oxide.

In certain embodiments, R and/or R¹ are ethylene oxide and the sum of a and b is from about 10 to about 50, from about 10 to about 40, from about 10 to about 30, or from about 20 to about 30.

In other embodiments, R and/or R¹ are polyethylene oxide and the sum of a and b is from about 10 to about 50, from about 10 to about 40, from about 10 to about 30, or from about 20 to about 30.

In further embodiments, R and/or R¹ are propylene oxide and the sum of a and b is from about 10 to about 50, from about 10 to about 40, from about 10 to about 30, or from about 20 to about 30.

PEI foam enhancers of the present invention may be modified or unmodified, with unmodified PEI polymers referring to polymers where R and R¹ are each H and modified PEI polymers including R and/or R¹ defined by any of the hydrocarbyl, alkyl, alkylene, etc. groups discussed above.

In accordance the foregoing discussion, suitable PEI foam enhancers include linear or branched PEI polymers having a molecular weight of from about 0.2 to about 100 kDa (e.g., from about 0.2 to about 30 kDa, or from about 2 to about 25 kDa) and containing (i.e., modified by) from about 10 to about 50 alkylene oxide groups (e.g., ethylene oxide, polyethylene oxide, and propylene oxide). In various embodiments, the PEI polymer contains from about 10 to about 40, from about 10 to about 30, or from about 20 to about 30 alkylene oxide groups.

### Firefighting Foam Concentrates

PEI foam enhancers may be incorporated into a firefighting foam concentrate in a proportion of at least about 0.1 wt %, at least about 0.5 wt %, at least about 1 wt %, at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 12 wt %, or at least about 15 wt %. Suitable concentrations of the PEI foam enhancer in the concentrate are typically at or above one of the listed values or limits and less than about 20 wt %, less than about 15 wt %, less than about 12 wt %, or less than about 10 wt %.

In various embodiments, the total proportion of PEI foam enhancer is at least about 0.5 wt %, at least about 1 wt %, or at least about 1.5 wt %. Suitable concentrations of PEI are typically at or above these limits and less than about 4 wt %, less than about 3 wt %, less than about 2.5 wt %, or less than about 2 wt %. For example, in certain embodiments, the total proportion of PEI foam enhancer is from about 0.5 wt % to about 2.5 wt %, or from about 1 wt % to about 2 wt %.

The PEI foam enhancers of the present invention may also be incorporated into other firefighting foam compositions, for example, foam premixes and foam forming solutions.

Firefighting foam concentrates and compositions suitable for use along with a (modified) PEI foam enhancer in accordance with the present invention include those described in U.S. patent application Ser. No. 17/516,097 (U.S. 2022/0124158 A1) entitled FLUORINE-FREE FIREFIGHTING FOAMS CONTAINING ONE OR MORE BIOPOLYMERS (Attorney Docker No. 18931C-000021-US), the entire contents of which are hereby incorporated by reference for all relevant purposes.

Additional firefighting foam concentrates and compositions suitable for use with a (modified) PEI foam enhancer in accordance with the present invention include those described in U.S. patent application Ser. No. 18/130,482 (U.S. 2023/0310918 A1) entitled FLUORINE-FREE FIREFIGHTING FOAMS FOR USE IN SPRINKLERS (Attorney Docket No. 18931C-000013-US), the entire contents of which are hereby incorporated by reference for all relevant purposes.

Other suitable firefighting foam concentrates and compositions include those described in U.S. patent application Ser. No. 18/889,866, filed Sep. 19, 2024, entitled FIREFIGHTING FOAMS CONTAINING ONE OR MORE SURFACTANTS AND A FOAM STABILIZER (Attorney Docket No. 18931C-000075-US), the entire contents of which are incorporated by reference herein for all relevant purposes; U.S. patent application Ser. No. 18/985,847, filed Dec. 18, 2024, entitled SELF-HEALING FIREFIGHTING FOAM CONCENTRATES AND FIREFIGHTING FOAM COMPOSITIONS FOR CLASS A AND CLASS B FIRES (Attorney 18931C-000081-US), the entire contents of which are incorporated by reference herein for all relevant purposes; and U.S. patent application Ser. No. 19/092,518, filed Mar. 27, 2025, entitled FLUORINE-FREE FIREFIGHTING FOAM COMPOSITIONS FOR LOW TEMPERATURE APPLICATIONS (Attorney Docket No. 18931C-000082-US), the entire contents of which are incorporated by reference herein for all relevant purposes.

For example, the compositions of the present disclosure may include any or all the various components listed below in the specified concentrations, ratios, etc.

### Surfactants

Often, the compositions of the present invention include one or more anionic surfactants, one or more amphoteric (zwitterionic) surfactants, and combinations thereof.

### Anionic Surfactants

Suitable anionic surfactants generally include sulfate surfactants, sulfonate surfactants, and combinations thereof.

Suitable sulfate surfactants include branched and/or linear alkoxylated (e.g., ethoxylated) sulfate surfactants, and salts thereof, and amine sulfate surfactants.

A sulfate surfactant may include a straight chain or branched alkyl group having at least 10 carbon atoms. The alkyl group of the sulfate surfactant(s) typically contains at least (or about) 10 carbon atoms, at least (or about) 11 carbon atoms, at least (or about) 12 carbon atoms (e.g., 12 carbon atoms), at least (or about) 13 carbon atoms, or at least (or about) 14 carbon atoms.

Typically, the alkyl group contains from about 10 to about 18 carbon atoms (e.g., C10-C18), more typically from about 10 about 16 carbon atoms (e.g., C10-C16), still more typically from about 10 to about 14 carbon atoms (e.g., C10-C14), and even more typically from about 12 to about 14 carbon atoms (e.g., C12-C14).

In certain embodiments, the alkyl group of a sulfate surfactant contains from about 12 to about 18 carbon atoms (e.g., C12-C18), more typically from about 12 about 16 carbon atoms (e.g., C12-C16), still more typically from about 12 to about 14 carbon atoms (e.g., C12-C14 or C12).

Overall, suitable alkyl sulfate surfactants include C8-C22, C8-C16, C8-C12, and C10-C12 alkyl sulfate surfactants, and salts thereof.

Suitable salts include ammonium, alkali metal (e.g., sodium), and alkaline earth (e.g., magnesium) salts. Other suitable salts include amine salts and ethanolamine salts (e.g., triethanolamine, TEA, salts) and phosphate salts.

With reference to a firefighting foam concentrate, the total proportion of anionic surfactant may be at least about 5 wt %, at least about 10 wt %, at least about 15 wt %, at least about 20 wt %, at least about 25 wt %, at least about 30 wt %, at least about 35 wt %, at least about 40 wt %, or even at least about 50 wt %,

In various embodiments, the total proportion of anionic surfactant in the foam concentrate may be less than about 60 wt %, less than about 50 wt %, or less than about 40 wt % and above any of the foregoing lower limits.

### Amphoteric (Zwitterionic) Surfactants

Suitable amphoteric surfactants include propionate surfactants, iminopropionate surfactants, betaine surfactants, sultaine surfactants, amine oxide surfactants, and salts thereof.

Suitable propionate surfactants include C6-C14 alkyl-iminodipropionate surfactants, and salts thereof. For example, suitable propionate surfactants include sodium octyliminodipropionate surfactants. Other suitable propionate surfactants include alkylamphopropionate surfactants.

Suitable betaine surfactants include a positively charged amino group and a negatively charged carboxylic acid group along with a straight or branched chain alkyl group. The alkyl group typically contains at least (or about) 10 carbon atoms, at least (or about) 11 carbon atoms, at least (or about) 12 carbon atoms (e.g., 12 carbon atoms), at least (or about) 13 carbon atoms, or at least (or about) 14 carbon atoms.

Typically, the alkyl group contains from about 10 to about 18 carbon atoms (e.g., C10-C18), more typically from about 10 about 16 carbon atoms (e.g., C10-C16), still more typically from about 10 to about 14 carbon atoms (e.g., C10-C14), and even more typically from about 12 to about 14 carbon atoms (e.g., C12-C14).

In certain embodiments, the alkyl group of the betaine surfactant contains from about 12 to about 18 carbon atoms (e.g., C12-C18), more typically from about 12 about 16 carbon atoms (e.g., C12-C16), still more typically from about 12 to about 14 carbon atoms (e.g., C12-C14 or C12).

Overall, suitable betaine surfactants include C8-C22 betaine surfactants. For example, suitable betaine surfactants include lauramidopropyl betaine, cocamidopropyl betaine, and combinations thereof.

Suitable sultaine surfactants include C8-C22 sultaine surfactants.

With reference to a firefighting foam concentrate, the total proportion of amphoteric surfactant may be at least about 5 wt %, at least about 10 wt %, at least about 15 wt %, at least about 20 wt %, at least about 25 wt %, at least about 30 wt %, at least about 35 wt %, at least about 40 wt %, or even at least about 50 wt %.

In various embodiments, the total proportion of amphoteric surfactant in the foam concentrate may be less than about 60 wt %, less than about 50 wt %, or less than about 40 wt % and above any of the foregoing lower limits.

### Solvents

### Organic Solvents

Further in accordance with the present invention, the compositions of the present invention may include one or more solvents that may constitute a solvent component present in the composition.

Typically, the solvent component is selected from fatty alcohols, alcohols, glycols, glycol ethers, terpenes, and combinations thereof.

Suitable fatty alcohols include those containing from 6 to 14 carbon atoms (i.e., C6-C14 fatty alcohols). Typically, one or more fatty alcohols may be present in the composition in a proportion of from about 0.2 wt % to about 3.5 wt %. The solvent component may include at least about 10 wt %, at least about 20 wt %, at least about 30 wt %, at least about 40 wt %, or at least about 50 wt % of one or more fatty alcohols (and/or in a proportion of less than about 90 wt %, less than about 80 wt %, less than about 70 wt %, less than about 60 wt %, or less than about 50 wt % of the solvent component).

Suitable alcohols include C4-C8 alkyl alcohols (linear and/or branched), and combinations thereof. One or more alcohols are typically present in the composition in a proportion of from about 0.25 wt % to about 4.0 wt %. Suitable alcohols include butanol and octanol. The solvent component may include at least about 10 wt %, at least about 20 wt %, at least about 30 wt %, at least about 40 wt %, or at least about 50 wt % of one or more alcohols (and/or in a proportion of less than about 90 wt %, less than about 80 wt %, less than about 70 wt %, less than about 60 wt %, or less than about 50 wt % of the solvent component).

Suitable glycol solvents, including alkyl glycols include C2-C10 glycols, C4-C8 glycols and C6-C8 glycols. Suitable glycols include propylene glycol, hexylene glycol, and combinations thereof. The glycols may be present in a proportion of from about 5 wt % to about 30 wt % of the composition. The solvent component may include at least about 10 wt %, at least about 20 wt %, at least about 30 wt %, at least about 40 wt %, or at least about 50 wt % of one or more glycols (and/or in a proportion of less than about 90 wt %, less than about 80 wt %, less than about 70 wt %, less than about 60 wt %, or less than about 50 wt % of the solvent component).

Suitable glycol ether solvents include C3-C10 glycol ethers, including C6-C10 glycol ethers. Suitable glycol ethers include butyl ether, 2-butoxyethanol, butyl carbitol, and combinations thereof. These ethers may be present in a proportion of from about 2 wt % to about 20 wt % of the composition. In various preferred embodiments, the solvent comprises butyl carbitol. The solvent component may include at least about 10 wt %, at least about 20 wt %, at least about 30 wt %, at least about 40 wt %, or at least about 50 wt % of one or more glycol ethers (and/or in a proportion of less than about 90 wt %, less than about 80 wt %, less than about 70 wt %, less than about 60 wt %, or less than about 50 wt % of the solvent component).

Suitable terpenes may be selected from the group consisting of d-limonene, pinene, myrcene, terpinene, p-cymene, and combinations thereof. The one or more terpenes may be present in a total proportion of from about 0.2 wt % to about 6 wt % of the solvent component. In various preferred embodiments, d-limonene is incorporated as a solvent. The solvent component may include at least about 10 wt %, at least about 20 wt %, at least about 30 wt %, at least about 40 wt %, or at least about 50 wt % of one or more terpenes (and/or in a proportion of less than about 90 wt %, less than about 80 wt %, less than about 70 wt %, less than about 60 wt %, or less than about 50 wt % of the solvent component).

### Sugar Component

Further in accordance with the present invention a sugar component may be included as an additional component.

Suitable sugars include white sugar, carmelized sugars, monosaccharides, disaccharides, polysaccharides, and combinations thereof.

Examples of carmelized sugars include brown sugars (e.g., dark brown sugars).

Suitable monosaccharides include d-xylose, dextrose, glucose, fructose, galactose, and combinations thereof.

Suitable disaccharides include sucrose.

With reference to firefighting foam concentrates, the sugar component is typically present in a concentration of at least about 10 wt %, at least about 15 wt %, or at least about 20 wt %. In accordance with certain embodiments, the sugar component is typically present in a concentration of from about 10 wt % to about 30 wt %, from about 10 wt % to about 25 wt %, or from about 15 wt % to about 25 wt %.

In addition to the foregoing, various firefighting foam concentrates and compositions incorporating such concentrates (e.g., foam forming solutions, foam premixes, foams, etc.) and others are described in the EMBODIMENTS section below.

### Foam Premixes and Solutions

Foam premixes and solutions of the present invention may be prepared by diluting a concentrate of the present invention with water and one or more other components.

Described herein are fluorine-free firefighting compositions, e.g., concentrates, foam solutions, foam-forming solutions, and foams. Fluorine-free may refer to and typically refers to compositions that do not include fluorine. Fluorine-free may also refer to compositions that do not include any fluorinated compound, such as a fluorinated surfactant, and polymers. In various embodiments, the compositions may be nearly entirely free of fluorine, or essentially free of fluorine. In such instances, the composition does not include added fluorine or fluorine-containing compounds. However, although not preferred, water or components of the compositions of the invention may include some minor portion of fluorine, but the compositions are nonetheless “fluorine-free” as defined herein and as understood in the art. Overall, any minor portion of fluorine does not exceed 1 part per trillion (ppt) or 0.1 ppt of the composition.

### Foams

Generally, the foams of the present invention are prepared by aspirating a foam solution of the present invention. Advantageously, the foams of the present invention exhibit enhanced fire performance and/or suitable or advantageous fire performance under certain conditions.

### Methods for Fighting Fires

The compositions and foams of the present invention are suitable for use in methods for combatting and/or extinguishing Class A and Class B fires where a composition or foam composition is applied directly or indirectly onto a Class A or Class B fire or the fuel ahead of a potentially advancing Class A or Class B fire front.

Having described the invention in detail, it will be apparent that modifications and variations are possible without departing from the scope of the invention defined in the appended claims.

### EXAMPLES

The following non-limiting examples are provided to further illustrate the present invention.

### Example 1

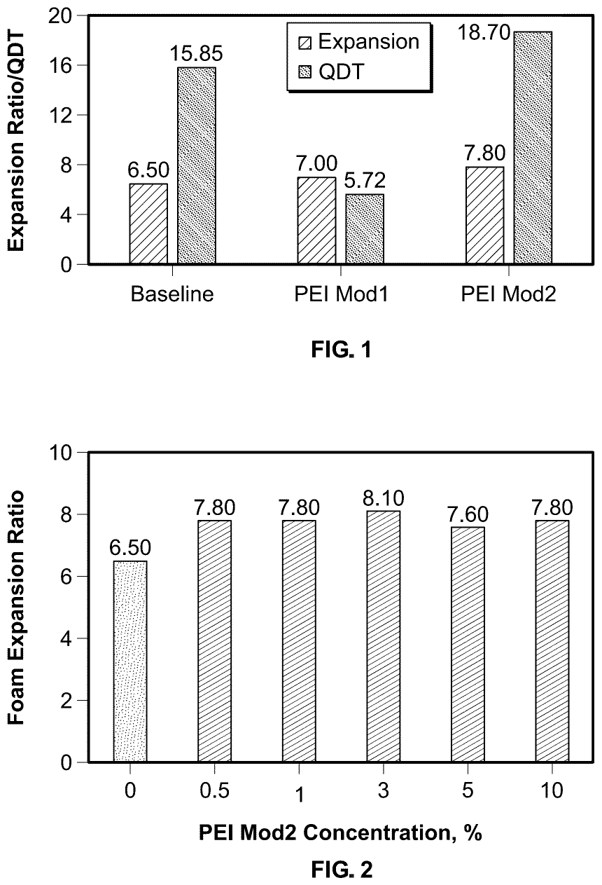

The following Example provides the results of incorporating modified PEI polymers in a commercial foam composition, in particular the effect on foam expansion ratio and quarter drain time (QDT). FIG. 1 provides results for the effect of PEI modification on fire-fighting foam expansion ratio and quarter drain time (QDT) for the following compositions:

$$Baseline = PERIMETER SOLUTIONS SOLBERG 3 \% SFFF$$

$$Mod 1 = PEI modified with polyethylene oxide ( PO )$$

$$Mod 2 = PEI modified with ethylene oxide ( oxyethylene )$$

The results for Expansion are shown in the bar graph on the left for each sample tested while the results for QDT are shown in the bar graph on the right.

The modifications were incorporated into concentrates of the baseline composition at a concentration of 1 wt %. As shown, incorporation of modified PEIs provides improvements in both foam expansion (ratio) and quarter drain time (QDT).

### Example 2

FIG. 2 demonstrates the effect of a modified PEI (Mod2) on foam expansion ratio for a commercial product at varying concentrations (0.5 wt %, 1 wt %, 3 wt %, 5 wt %, and 10 wt %). The commercial product (0 concentration entry) is PERIMETER SOLUTIONS SOLBERG 3% SFFF.

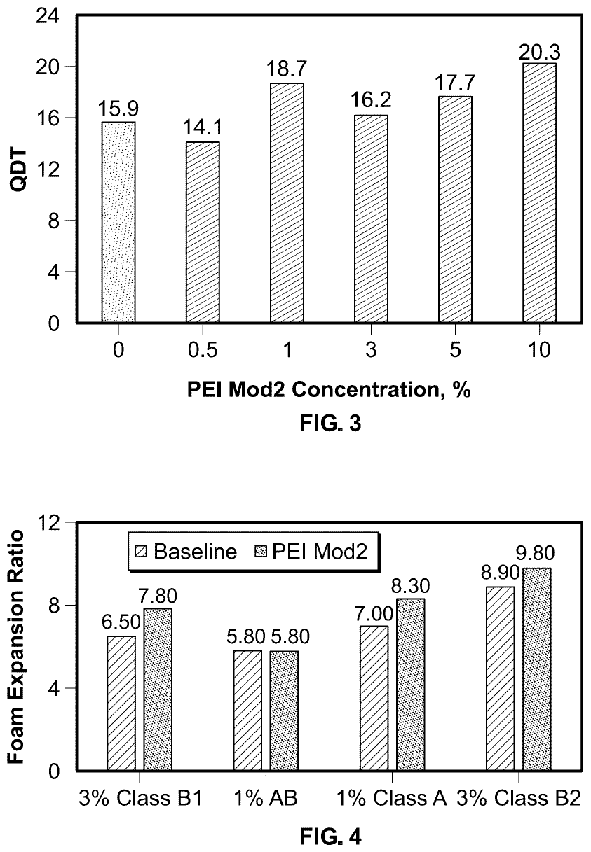

FIG. 3 demonstrates the effect of a modified PEI (Mod2) on quarter drain time (QDT) for a commercial product at varying concentrations (0.5 wt %, 1 wt %, 3 wt %, 5 wt %, and 10 wt %). The commercial product (0 concentration entry) is PERIMETER SOLUTIONS SOLBERG 3% SFFF.

As shown, use of the modified PEI provides improvements in foam expansion ratio and QDT. The commercial baseline product used as a comparison is an effective commercially available foam. The improvements shown, e.g., an increase of more than 1 unit for the foam expansion and increases in QDT, are currently believed to indicate a significant improvement in performance.

### Example 3

The following example describes the effect of oxyethylene modified PEI (Mod2) on commercial products at a concentration of the modified PEI of 1 wt % (of the commercial concentrate formulation having the modified PEI added thereto).

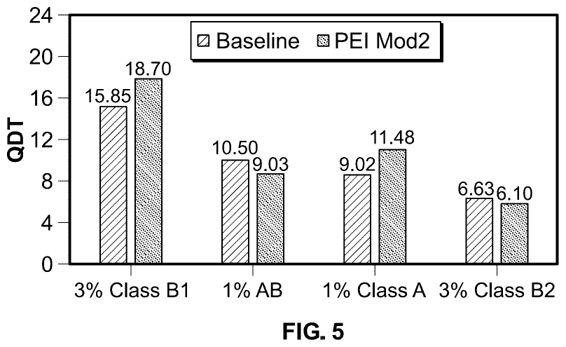

FIG. 4 demonstrates the effect of PEI Mod2 on foam expansion ratio. FIG. 5 demonstrates the effect of PEI Mod2 on quarter drain time. The following products were tested:

$$Class B 1 and B 2 products = PERIMETER SOLUTIONS SOLBERG 3 \% SFFF products ;$$

$$Class AB = 1 \% FF CLASS A / B FOAM ;$$

$$Class A = CLASS A FOAM .$$

The results for the baseline formulations not including the modified PEI are shown in the bar graphs on the left in the above Figures. As shown in these results, adding the modified PEI provided foam boosting effects for multiple, different foam technologies.

These results indicate modified PEI is generally compatible with different technologies, e.g., Class A foam, Class A/B foam, and Class B foam with no detrimental effect on foam qualities. The modified PEI was very effective in increasing foam quality for the above commercial products, in particular the tested Class B1 (SOLBERG Newtonian SFFF series) and Class A (PHOS-CHEK series) foams. For example, for the 1% CLASS A foam, the foam expansion increased from 7.00 to 8.30 (i.e., the increase is >1), and the drain time increased from 9.02 to 11.48 minutes (27% increase). These results are considered significant as the commercial products tested are effective and the increase in foam expansion ratio was greater than 1 and the drain time increase was over 25%.

### EMBODIMENTS

For further illustration, additional non-limiting embodiments of the present invention are set forth below. These Embodiments describe compositions and components of compositions that may be incorporated into foam compositions including a foam enhancer comprising a (linear or branched) polyethyleneimine (PEI) polymer in accordance with the present disclosure.

Embodiment 1 comprises a firefighting foam concentrate, the concentrate comprising: at least one anionic surfactant; at least one amphoteric surfactant; and polyethylene glycol (PEG).

Embodiment 2 comprises the composition of Embodiment 1, wherein the concentrate comprises PEG 20000, PEG 30000, PEG 35000, or a combination thereof.

Embodiment 3 comprises the composition of Embodiment 1 or 2, wherein the concentrate further comprises glycerin (propane-1,2,3-triol).

Embodiment 4 comprises the composition of Embodiment 1 or 2, wherein the concentrate further comprises a sugar component.

Embodiment 5 comprises a firefighting foam concentrate, the concentrate comprising: at least one anionic surfactant; at least one amphoteric surfactant; and glycerin (propane-1,2,3-triol), wherein glycerin constitutes at least about 5 wt %, at least about 8 wt %, or at least about 10 wt % of the concentrate composition.

Embodiment 6 comprises a firefighting foam concentrate, the concentrate comprising: at least one anionic surfactant; at least one amphoteric surfactant; the composition further comprising: polyethylene glycol, and/or glycerin, and/or a sugar component, wherein: the composition does not contain any sultaine surfactant.

Embodiment 7 comprises the composition of any of the preceding Embodiments, wherein the at least one anionic surfactant comprises a branched and/or linear alkoxylated sulfate surfactant, or a salt thereof, or an amine sulfate surfactant.

Embodiment 8 comprises the composition of any of the preceding Embodiments, wherein the at least one anionic surfactant comprises C8-C22, C8-C16, C8-C12, or C10-C12 alkyl sulfate surfactant, or a salt thereof.

Embodiment 9 comprises the composition of any of the preceding Embodiments, wherein the at least one anionic surfactant comprises at least one alkyl sulfate surfactant having a straight carbon chain having a length of at least 8 carbon atoms.

Embodiment 10 comprises the composition of any of the preceding Embodiments, wherein the total proportion of anionic surfactant is at least about 4 wt %, at least about 6 wt %, at least about 8 wt %, from about 4 wt % to about 12 wt %, from about 6 wt % to about 10 wt %, or from about 7 wt % to about 9 wt %.

Embodiment 11 comprises the composition of any of the preceding Embodiments, wherein the at least one amphoteric surfactant is selected from propionate surfactants, betaine surfactants, amine oxide surfactants, and salts and combinations thereof.

Embodiment 12 comprises the composition of Embodiment 11 wherein the at least one amphoteric surfactant comprises a C6-C14 alkyl-iminodipropionate surfactant, or a salt thereof.

Embodiment 13 comprises the composition of Embodiment 11 wherein the at least one amphoteric surfactant comprises a C8-C22 betaine surfactant, or a salt thereof.

Embodiment 14 comprises the composition of any of the preceding Embodiments, wherein the at least one amphoteric surfactant is present in a concentration of at least about 10 wt %, at least about 14 wt %, at least about 18 wt %, from about 10 wt % to about 30 wt %, from about 14 wt % to about 26 wt %, or from about 18 wt % to about 22 wt %.

Embodiment 15 comprises the composition of any of the preceding Embodiments, wherein the weight ratio of the at least one anionic surfactant to the at least one amphoteric surfactant is from about 1:5 to about 5:1, from about 1:4 to about 4:1, from about 1:3 to about 3:1, from about 1:2 to about 3:1, or about 2.5:1.

Embodiment 16 comprises the composition of any of the preceding Embodiments, wherein the sugar component comprises white sugar, a carmelized sugar, a monosaccharide, a disaccharide, a polysaccharide, or a combination thereof.

Embodiment 17 comprises the composition of Embodiment 16, wherein the sugar component comprises a carmelized brown sugar.

Embodiment 18 comprises the composition of Embodiment 16, wherein the sugar component comprises a monosaccharide selected from the group consisting of d-xylose, dextrose, glucose, fructose, galactose, and combinations thereof.

Embodiment 19 comprises the composition of any of the preceding Embodiments, wherein a sugar component is present in a concentration of at least about 10 wt %, at least about 15%, at least about 20%, from about 10 wt % to about 30 wt %, from about 10 wt % to about 25 wt %, or from about 15 wt % to about 25 wt %.

Embodiment 20 comprises the composition of any of the preceding Embodiments, wherein glycerin (propane-1,2,3-triol) is present in a proportion of at least about 8 wt %, at least about 10 wt %, at least about 12 wt %, from about 8 wt % to about 20 wt %, from about 10 wt % to about 20 wt %, from about 12 wt % to about 18 wt %, or about 15 wt %.

Embodiment 21 comprises the composition of any of the preceding Embodiments, wherein the sugar component and glycerin are present in a weight ratio of from about 1:5 to about 5:1, from about 1:4 to about 4:1, or from about 1:3 to about 3:1

Embodiment 22 comprises the composition of any of the preceding Embodiments, wherein the composition is substantially free or free of any sultaine surfactants.

Embodiment 23 comprises a firefighting foam solution, the solution comprising any of the concentrates of the preceding Embodiments, wherein the solution contains at least or about 0.5 wt %, 1 wt %, 1.5%, 2 wt %, 3 wt %, 4 wt %, 5 wt %, or 6 wt % of the foam concentrate.

Embodiment 101 comprises a fluorine-free firefighting foam concentrate, the concentrate comprising: a betaine surfactant; a first sulfate surfactant; a second sulfate surfactant; and a solvent selected from the group consisting of hexylene glycol, propylene glycol, propylene glycol n-butyl ether, and combinations thereof, wherein the concentrate is free of any polysaccharide and/or biopolymer thickener.

Embodiment 102 comprises a fluorine-free firefighting foam concentrate, the concentrate comprising: a C10-C14 betaine surfactant; a first C10-C14 sulfate surfactant; a second C10-C14 sulfate surfactant; and a solvent selected from glycols, glycol ethers, and combinations thereof; wherein the concentrate is free of any polysaccharide and/or biopolymer thickener.

Embodiment 103 comprises a fluorine-free firefighting foam concentrate, the concentrate comprising: a C10-C14 betaine surfactant; a first C10-C14 sulfate surfactant; a second C10-C14 sulfate surfactant; and a solvent selected from glycols, glycol ethers, and combinations thereof, wherein: the betaine surfactant is present in a concentration of from about 10 wt % to about 50 wt %, based on the total weight of the concentrate; the first sulfate surfactant constitutes from about 2 wt % to about 25 wt %, based on the total weight of the concentrate; the second sulfate surfactant constitutes from about 1 wt % to about 20 wt %, based on the total weight of the concentrate; and the solvent constitutes from about 2 wt % to about 15 wt %, based on the total weight of the concentrate.

Embodiment 104 comprises the concentrate of any of Embodiments 100 to 103, wherein the betaine surfactant is a C12 surfactant.

Embodiment 105 comprises the concentrate of any of Embodiments 100 to 104, wherein the first sulfate surfactant is a C12 surfactant.

Embodiment 106 comprises the concentrate of any of Embodiments 100 to 105, wherein the second sulfate surfactant is a C12 surfactant.

Embodiment 107 comprises the concentrate of any of Embodiments 100 to 106, wherein the solvent is hexylene glycol.

Embodiment 108 comprises the concentrate of any of Embodiments 100 to 107, wherein the solvent is butyl carbitol.

Embodiment 109 comprises the concentrate of any of Embodiments 100 to 108, wherein the solvent comprises butyl carbitol and PnB.

Embodiment 110 comprises the concentrate of any of Embodiments 100 to 109, wherein: the weight ratio of the betaine surfactant to the first sulfate surfactant is from about 4:1 to about 1:1; and/or the weight ratio of the betaine surfactant to the second sulfate surfactant is from about 20:1 to about 1:0.5; and/or the weight ratio of the first sulfate surfactant to the second sulfate surfactant is from about 20:1 to about 2:1.

Embodiment 111 comprises the concentrate of any of Embodiments 100 to 110, wherein: the weight ratio of the betaine surfactant to the solvent is from about 1:1 to about 1:0.3; and/or the weight ratio of the first sulfate surfactant to the solvent is from about 1:1 to about 5:1; and/or the weight ratio of the second sulfate surfactant to the solvent is from about 10:1 to about 1:70.

Embodiment 112 comprises the concentrate of any of Embodiments 101 to 111, wherein the concentrate further comprises at least one additional solvent selected from the group consisting of hexylene glycol, propylene glycol, butyl carbitol, propylene glycol n-butyl ether (PnB), and combinations thereof.

Embodiment 113 comprises the concentrate of Embodiment 112, wherein the concentrate comprises one additional solvent.

Embodiment 114 comprises the concentrate of claim 113, wherein the additional solvent constitutes from about 1 wt % to about 20 wt %, or from about 2 wt % to about 15 wt %, based on the total weight of the concentrate.

Embodiment 115 comprises the concentrate of Embodiment 112, wherein the concentrate comprises two additional solvents, a second solvent and a third solvent.

Embodiment 116 comprises the concentrate of Embodiment 115, wherein the second solvent constitutes from about 1 wt % to about 15 wt %, or from about 2 wt % to about 12 wt %, based on the total weight of the concentrate.

Embodiment 117 comprises the concentrate of Embodiment 115 or 116, wherein the third solvent constitutes from about 1 wt % to about 15 wt %, or from about 2 wt % to about 12 wt %, based on the total weight of the concentrate.

Embodiment 118 is the concentrate of any of Embodiments 115 to 117, wherein the weight ratio of the first solvent to the second solvent is from about 2:1 to about 1:1.

Embodiment 119 is the concentrate of any of Embodiments 115 to 118, wherein the weight ratio of the second solvent to the third solvent is from about 2:1 to about 2:1.

Embodiment 120 is the concentrate of any of Embodiments 115 to 119, wherein the second solvent is hexylene glycol and the third solvent is propylene glycol, butyl carbitol, or PnB.

Embodiment 121 is the concentrate of any of Embodiments 115 to 119, wherein the second solvent is propylene glycol and the third solvent is butyl carbitol or PnB.

Embodiment 122 is the concentrate of any of Embodiments 115 to 119, wherein the second solvent is butyl carbitol and the third solvent is PnB.

Embodiment 123 is the concentrate of any of Embodiments 101 to 122, wherein the concentrate further comprises a fire performance enhancer comprising: a further surfactant, selected from propionate surfactants (e.g., iminodipropionate surfactants), sulfate surfactants (e.g., sulfate surfactant containing 0-10 or 0-6 ethylene oxide (EO) units, and combinations thereof; and/or polymers selected from polyethylene glycol (PEG) (e.g., PEG having a molecular weight above 1000), and combinations thereof; and/or a triol compound selected from glycols and glycerols selected from the group consisting of glycerin, ethylene oxide, and combinations thereof.

Embodiment 124 is the concentrate of Embodiment 123, wherein the fire performance enhancer comprises: a C8-C16 propionate surfactant; a sulfate surfactant containing from 0-6 EO; glycerin; and PEG.

Embodiment 125 is the concentrate of Embodiment 123 or 124, wherein the fire performance enhancer comprises a propionate surfactant and/or sulfate surfactant in a concentration of from about 0.1 wt % to about 5 wt %, or from about 0.1 wt % to about 3 wt %.

Embodiment 126 comprises the concentrate of any of Embodiments 123 to 125, wherein the fire performance enhancer comprises a polymer in a proportion of from about 0.1 wt % to about 5 wt %.

Embodiment 127 comprises the concentrate of Embodiment 126, wherein the fire performance enhancer comprises polyethylene glycol (PEG) having a molecular weight greater than about 1000.

Embodiment 128 comprises the concentrate of Embodiment 123, wherein the fire performance enhancer comprises a triol in a proportion of from about 1 wt % to about 25 wt %.

Embodiment 129 is a fire retardant solution, the solution prepared by diluting with water the fire retardant concentrate of any of Embodiments 101 to 111, wherein the solution passes the following military specifications (Milspec) for use in Class B fires: Gasoline (for a 3 wt % concentrate solution); Jet A (for a 3 wt % concentrate solution); Jet A (for a 1.5 wt % concentrate solution); Jet A Purple K (for a 3 wt % concentrate solution); Jet A (for a 6 wt % concentrate solution); Jet A 50 ft2 (for a 3 wt % concentrate solution); Gasoline (for a 3 wt % aged concentrate solution); Jet A (for a 3 wt % aged concentrate solution); Jet A (for a 1.5 wt % aged concentrate solution).

Embodiment 130 is a fire retardant solution, the solution prepared by diluting with water the fire retardant concentrate of any of Embodiments 101 to 11, wherein the solution passes Underwriters Laboratory (UL) standard 162 sprinkler testing for use in commercial/industrial applications.

Embodiment 131 is the solution of Embodiment 130 wherein the solution passes the extinguishment and/or water deluge portion of UL 162.

Embodiment 132 is the composition of Embodiment 130 wherein the solution passes the extinguishment portion of UL 162.

Embodiment 133 is a fire retardant solution, the solution prepared by diluting with water the fire retardant concentrate of any of claims 101 to 111, wherein the solution passes Factory Mutual (FM) sprinkler testing standard 5130.

Embodiment 134 is a fire retardant solution, the solution prepared by diluting with water the fire retardant concentrate of any of Embodiments 101 to 111, wherein the solution passes Military Specification (Milspec).

Embodiment 135 is a fire retardant solution, the solution prepared by diluting with water the fire retardant concentrate of any of Embodiments 101 to 111, wherein the solution passes the United States Forest Service (USFS) wetting test for Class A fire performance.

Embodiment 136 is a fire retardant solution, the solution prepared by diluting with water the fire retardant concentrate of any of Embodiments 101 to 111, wherein the solution passes Vehicle Fire AS-5062 test for Class B fire performance.

Embodiment 137 is a firefighting foam prepared from any of the concentrates or solutions of the preceding Embodiments.

Embodiment 138 wherein the firefighting foam of Embodiment 137 is a Newtonian foam.

Embodiment 139 is the firefighting foam of Embodiment 137 or 138 wherein the foam exhibits a quarter drain time (QDT) of at least about 10 minutes, at least about 15 minutes, at least about 20 minutes, at least about 25 minutes, at least about 30 minutes, at least about 35 minutes, or at least about 40 minutes.

Embodiment 201 comprises fluorine-free firefighting foam composition, the composition comprising: water; a surfactant component comprising: (i) one or more branched chain surfactants selected from anionic surfactants, amphoteric surfactants, and combinations thereof and (ii) one or more linear chain surfactants selected from anionic surfactants, amphoteric surfactants, and combinations thereof; a solvent component comprising one or more solvents, wherein the one or more solvents are selected from the group consisting of fatty alcohols, alcohols, glycols, glycol ethers, terpenes, and combinations thereof; wherein: the composition is in the form of a firefighting foam concentrate having a freezing point below 2° C. (35° F.); or the composition is in the form of a firefighting foam premix and the premix is a flowable liquid at temperatures of 0° C. or below, −10° C. or below, −20° C. or below, −30° C. or below, or −40° C. or below, and wherein: the weight ratio of branched chain surfactants to linear chain surfactants in the surfactant component is at least about 1:1, at least about 1.5:1, at least about 2:1, at least about 2.5:1, or at least about 3:1.

Embodiment 202 comprises the composition of Embodiment 201 wherein the weight ratio of branched chain surfactants to linear chain surfactants in the surfactant component is less than about 5:1, less than about 3:1, or less than about 1.5:1.

Embodiment 203 comprises the composition of Embodiment 201 or 202 wherein the surfactant component comprises at least about 0.5 wt % branched chain anionic surfactants, or from about 1.2 wt % to about 8 wt % branched chain anionic surfactants.

Embodiment 204 comprises the composition of any one of Embodiments 201 to 203 wherein the branched chain anionic surfactants are selected from the group consisting of sulfate surfactants, ethoxylated sulfate surfactants, phosphate sulfate surfactants, and combinations thereof.

Embodiment 205 comprises the composition of any one of Embodiments 201 to 204 wherein the surfactant component comprises at least about 0.5 wt % branched chain amphoteric/zwitterionic surfactants, or from about 1 wt % to about 20 wt % branched chain amphoteric/zwitterionic surfactants.

Embodiment 206 comprises the composition of any one of Embodiments 201 to 205 wherein the branched chain amphoteric surfactants are selected from the group consisting of betaine surfactants, iminopropionate surfactants, sultaine surfactants, and combinations thereof.

Embodiment 207 comprises the composition of any one of Embodiments 201 to 206 wherein the surfactant component comprises at least about 0.5 wt % linear chain anionic surfactants, or from about 8 wt % to about 55 wt % linear chain anionic surfactants.

Embodiment 208 comprises the composition of any one of Embodiments 201 to 207 wherein the linear chain anionic surfactants are selected from the group consisting of sulfate surfactants, ethoxylated sulfate surfactants, phosphate sulfate surfactants, and combinations thereof.

Embodiment 209 comprises the composition of any one of Embodiments 201 to 208 wherein the surfactant component comprises at least about 5 wt % linear chain amphoteric surfactants, or from about 8 wt % to about 35 wt % linear chain amphoteric surfactants.

Embodiment 210 comprises the composition of any one of Embodiments 201 to 209 wherein the linear chain amphoteric surfactants are selected from the group consisting of betaine surfactants, iminopropionate surfactants, sultaine surfactants, and combinations thereof.

Embodiment 211 comprises a fluorine-free firefighting foam composition, the composition comprising: water; a surfactant component comprising one or more anionic surfactants, one or more amphoteric surfactants, and combinations thereof; a solvent component comprising: (i) one or more branched chain solvents selected from the group consisting of fatty alcohols, alcohols, glycols, glycol ethers, and combinations thereof; and (ii) one or more linear chain solvents selected from the group consisting of fatty alcohols, alcohols, glycols, glycol ethers, and combinations thereof; wherein: the composition is in the form of a firefighting foam concentrate having a freezing point below 2° C. (35° F.); or the composition is in the form of a firefighting foam premix that is a flowable liquid at temperatures of 0° C. or below, −10° C. or below, −20° C. or below, −30° C. or below, or −40° C. or below, and wherein: the weight ratio of branched chain solvents to linear chain solvents in the solvent component is at least about 1:1, at least about 1.5:1, at least about 2:1, at least about 2.5:1, or at least about 3:1.

Embodiment 212 comprises the composition of Embodiment 211 wherein the weight ratio of branched chain solvents to linear chain solvents in the solvent component is less than about 5:1, less than about 2:1, or less than about 1.5:1.

Embodiment 213 comprises the composition of Embodiment 211 or 212 wherein the branched solvents are selected from the group consisting of hexylene glycol, propylene glycol n-butyl ether (PnB), d-limonene, and combinations thereof.

Embodiment 214 comprises the composition of any one of Embodiments 211 to 213 wherein the linear chain solvents are selected from the group consisting of butyl carbitol, ethylene glycol, polyethylene glycol, and combinations thereof.

Embodiment 215 comprises a fluorine-free firefighting foam composition, the composition comprising: a surfactant component comprising one or more anionic surfactants, one or more amphoteric surfactants, and combinations thereof; a solvent component comprising one or more solvents, wherein the one or more solvents are selected from the group consisting of fatty alcohols, alcohols, glycols, glycol ethers, terpenes, and combinations thereof; wherein: the composition is in the form of a firefighting foam concentrate having a freezing point below 2° C. (35° F.); and/or the composition is in the form of a firefighting foam premix that is a flowable liquid at temperatures of 0° C. or below, −10° C. or below, −20° C. or below, −30° C. or below, or −40° C. or below, and wherein: the solvent component comprises one or more the following: (i) one or more fatty alcohols, in a total proportion of from about 0.2 wt % to about 3.5 wt % of the solvent component, and/or (ii) one or more alcohols, in a total proportion of from about 0.25 wt % to about 4.0 wt % of the solvent component, and/or (iii) one or more glycols, in a total proportion of from about 5 wt % to about 30 wt % of the solvent component, and/or (iv) one or more glycol ethers, in a total proportion of from about 2 wt % to about 20 wt % of the solvent component, and/or (v) one or more terpenes (d-limonene) in a total proportion of from about 0.2 wt % to about 6 wt % of the solvent component.

Embodiment 216 comprises the composition of any of Embodiments 201 to 215 wherein a foam premix contains from about 0.5 wt % to about 2 wt % of the composition of any of the preceding claims, from about 30 wt % to about 60 wt % of a premix solvent, and water.

Embodiment 217 comprises the composition of Embodiment 215 or 216 wherein: the fatty alcohols contain from 6 to 14 carbon atoms; the alcohols are selected from the group consisting of C6-C4 alkyl alcohol (linear and/or branched), and combinations thereof; the glycols are selected from the group consisting of propylene glycol, hexylene glycol, and combinations thereof; the glycol ethers are selected from the group consisting of butyl ether, 2-butoxyethanol, butyl carbitol, and combinations thereof; and the terpenes are selected from the group consisting of d-limonene, pinene, myrcene, terpinene, p-cymene, and combinations thereof.

Embodiment 218 comprises the composition of any one of Embodiments 215 to 217, wherein the solvent component comprises: (i)-(v); (i)-(iv), (i)-(iii), (i)-(ii), or (i); (ii)-(v) (ii)-(iv), (ii)-(iii), or (ii); (iii)-(v), (iii)-(iv), or (iii); (iv)-(v); or (iv); or (v).

Embodiment 219 comprises the composition of any one of Embodiments 215 to 218 wherein the composition is free of any organic or inorganic salt.

Embodiment 220 comprises a fluorine-free firefighting foam concentrate composition, the composition comprising: water; a surfactant component comprising one or more anionic surfactants, one or more amphoteric surfactants, and combinations thereof; a solvent component comprising d-limonene and one or more solvents are selected from the group consisting of fatty alcohols, glycols, glycol ethers, and combinations thereof; wherein: d-limonene constitutes from about 0.1 wt % to about 2 wt % of the foam concentrate.

Embodiment 221 comprises the composition of Embodiment 220, wherein the composition further comprises a glycol ether solvent selected from the group consisting of butyl carbitol, propylene glycol n-butyl ether (PnB), and combinations thereof.

Embodiment 222 comprises the composition of Embodiment 220 or 221 wherein the composition comprises: from about 0.1 to about 1.0 wt % fatty alcohols; from about 15 wt % to about 30 wt % of glycol ether solvents; from about 30 wt % to about 40 wt % amphoteric surfactants; and from about 15 wt % to about 25 wt % of anionic surfactants.

Embodiment 223 comprises the composition of Embodiment 220 or 221 wherein the composition comprises: from about 15 wt % to about 30 wt % of glycol ether solvents; from about 20 wt % to about 30 wt % amphoteric surfactants; and from about 20 wt % to about 30 wt % of anionic surfactants.

Embodiment 224 comprises the composition of Embodiment 220 or 221 wherein the composition comprises: from about 0.1 to about 2.5 wt % fatty alcohols; from about 15 wt % to about 30 wt % of glycol ether solvents; from about 10 wt % to about 20 wt % amphoteric surfactants; and from about 45 wt % to about 65 wt % of anionic surfactants.

Embodiment 225 comprises the composition of Embodiment 220 or 221 wherein the composition comprises: from about 0.1 to about 3.5 wt % fatty alcohols; from about 15 wt % to about 30 wt % of glycol ether solvents; and from about 45 wt % to about 65 wt % of anionic surfactants.

Embodiment 226 comprises a fluorine-free firefighting foam concentrate composition, the composition comprising: water; a surfactant component comprising one or more anionic surfactants, one or more amphoteric surfactants, and combinations thereof; a solvent component comprising one or more solvents are selected from the group consisting of fatty alcohols, glycols, glycol ethers, terpenes, and combinations thereof; wherein:
anionic surfactants constitute at least about 50 wt % of the surfactant component.

Embodiment 227 comprises a fluorine-free firefighting foam concentrate composition, the composition comprising: water; a surfactant component comprising one or more anionic surfactants, one or more amphoteric surfactants, and combinations thereof; a solvent component comprising one or more solvents are selected from the group consisting of fatty alcohols, glycols, glycol ethers, terpenes, and combinations thereof; wherein: the weight ratio of anionic surfactant to amphoteric surfactant in the surfactant component is from about 60:40 to about 40:60, from about 55:45 to about 45:55, or about 50:50.

Embodiment 228 comprises the composition of Embodiment 227, wherein the surfactant component constitutes at least about 70 wt %, at least about 75 wt %, at least about 80 wt %, or at least about 85 wt % of the composition.

Embodiment 229 comprises a fluorine-free firefighting foam concentrate composition, the composition comprising: water; d-limonene in a proportion of from about 0.1 wt % to about 10 wt % of the concentrate; a surfactant component comprising one or more anionic surfactants, one or more amphoteric surfactants, and combinations thereof; and a solvent component comprising one or more solvents selected from the group consisting of fatty alcohols, glycols, glycol ethers, and combinations thereof, wherein the composition comprises: from about 0.1 wt % to about 5 wt % of one or more alcohol or fatty alcohols; from about 1 wt % to about 60 wt % of glycol ether solvents; from about 25 wt % to about 60 wt % of anionic surfactants; and from about 10 wt % to about 40 wt % amphoteric surfactants; and wherein the composition exhibits 1% Drave Test Wetting Results of at least 8 seconds(s).

Embodiment 230 comprises a fluorine-free high expansion firefighting foam, the composition comprising: a surfactant component consisting of one or more anionic surfactants, and one or more amphoteric surfactants, wherein the anionic surfactants constitute from about 15 wt % to about 60 wt % of the composition, and the amphoteric surfactants constitute from about 20 wt % to about 50 wt % of the composition; and the composition exhibits an expansion ratio of at least about 200, at least about 400, at least about 600, or at least about 800.

Embodiment 231 comprises a fluorine-free firefighting foam concentrate composition, the composition comprising: water; d-limonene in a proportion of from about 0.1 wt % to about 3 wt % of the concentrate; a surfactant component comprising one or more anionic surfactants, one or more amphoteric surfactants, and combinations thereof; and a solvent component comprising one or more solvents selected from the group consisting of fatty alcohols, glycols, glycol ethers, and combinations thereof, wherein the composition comprises: from about 0.1 wt % to about 5 wt % of one or more alcohols or fatty alcohols; from about 1 wt % to about 60 wt % of glycol ether solvents; from about 1 wt % to about 10 wt % of anionic surfactants; and from about 10 wt % to about 60 wt % amphoteric surfactants; and wherein the concentrate composition passes Vehicle system fire testing conducted at −40° C.

Embodiment 232 is a fluorine-free firefighting foam concentrate composition, the composition comprising: water; d-limonene in a proportion of from about 0.1 wt % to about 3 wt % of the concentrate; surfactant component consisting of one or more amphoteric surfactants, and combinations thereof; and a solvent component comprising one or more solvents selected from the group consisting of fatty alcohols, glycols, glycol ethers, and combinations thereof, wherein the composition comprises: from about 0.1 wt % to about 5 wt % of one or more alcohols or fatty alcohols; from about 1 wt % to about 60 wt % of glycol ether solvents; and from about 10 wt % to about 60 wt % amphoteric surfactants; and wherein the concentrate composition passes Vehicle system fire testing conducted at −40° C.

Embodiment 233 is a firefighting foam premix, the premix containing from about 0.5 wt % to about 2 wt % of the composition of any of the preceding claims, from about 30 wt % to about 60 wt % of a premix solvent, and water, wherein the premix is a flowable liquid below temperatures of 0° C., −10° C., −20° C., −30° C., or −40° C.

Embodiment 234 is the premix of Embodiment 233 containing approximately 1 wt % of the composition of any of Embodiments 201 to 232.

Embodiment 235 comprises the premix of Embodiment 233 or 234 wherein water constitutes from about 40 wt % to about 70 wt %.

Example embodiments have been provided so that this disclosure will be thorough, and will fully convey the scope to those who are skilled in the art. Numerous specific details are set forth such as examples of specific compositions, components, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The compositions, components, method steps, processes, and operations described herein are not to be construed as necessarily requiring their performance in the particular order discussed or illustrated, unless specifically identified as an order of performance. It is also to be understood that additional or alternative components, steps, etc. may be employed.

Although the terms first, second, third, etc. may be used herein to describe various elements, components, etc., these elements, components, etc., should not be limited by these terms. These terms may be only used to distinguish one element, component, etc. from another element, component, etc. Terms such as “first,” “second,” and other numerical terms when used herein do not imply a sequence or order unless clearly indicated by the context. Thus, a first element, component, etc. discussed below could be termed a second element, component, etc. without departing from the teachings of the example embodiments.

As various changes could be made in the above compositions and methods without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

What is claimed is:

1. A firefighting foam composition, the composition comprising a foam enhancer comprising a linear or branched polyethyleneimine (PEI) polymer, wherein the PEI polymer is represented by the following formula: 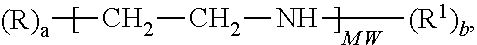
wherein:
the molecular weight of the PEI polymer (—[—CH₂—CH₂—NH—]_{MW}—) is from about 0.2 kilodaltons (kDa) to about 800 (kDa), and R and R¹ are independently selected from H, hydrocarbyl, and substituted hydrocarbyl groups.

2. The composition of claim 1 wherein the PEI polymer has a molecular weight of from about 0.2 to about 100 kDa, from about 0.2 to about 30 kDa, from about 0.2 to about 25 kDa, or from about 2 kDa to about 30 kDa.

3. The composition of claim 1 wherein R and R¹ are independently selected from substituted or unsubstituted, linear or branched alkyl groups and substituted or unsubstituted, linear or branched alkylene groups; or
R and R¹ are independently selected from C1-C10 alkyl groups, C2-C8 alkyl groups, C2-C6 alkyl groups, and C2-C4 alkyl groups; or
R¹ are independently selected from C1-C10 alkylene groups, C2-C8 alkylene groups, C2-C6 alkylene groups, and C2-C4 alkylene groups.

4. (canceled)

5. (canceled)

6. The composition of claim 1 wherein the sum of a and b is from about 1 to about 50, from about 5 to about 45, from about 10 to about 30, from about 10 to about 20, or from about 20 to about 30.

7. The composition of claim 1 wherein R and R¹ are independently selected from ethylene oxide (EO), polyethylene oxide (PEO), and propylene oxide (PO); or
R and/or R¹ are ethylene oxide and the sum of a and b is from 10 to 50, from 10 to 40, from 10 to 30, or from 20 to 30; or
R and/or R¹ are polyethylene oxide and the sum of a and b is from 10 to 50, from 10 to 40, from 10 to 30, or from 20 to 30; or
R and/or R¹ are propylene oxide and the sum of a and b is from 10 to 50, from 10 to 40, from 10 to 30, or from 20 to 30.

8. (canceled)

9. (canceled)

10. (canceled)

11. A firefighting foam composition, the composition comprising a modified polyethylene (PEI) foam enhancer having a molecular weight of from about 0.2 to about 30 kDa and containing from about 10 to about 50 alkylene oxide groups selected from the group consisting of ethylene oxide, polyethylene oxide, and propylene oxide.

12. The composition of claim 1 wherein the composition comprises or is prepared from a firefighting foam concentrate, the concentrate comprising:
at least one anionic surfactant;
at least one amphoteric surfactant; and
polyethylene glycol (PEG).

13. The composition of claim 11 wherein the composition comprises or is prepared from a firefighting foam concentrate, the concentrate comprising:
at least one anionic surfactant;
at least one amphoteric surfactant; and
glycerin (propane-1,2,3-triol), wherein glycerin constitutes at least about 5 wt %, at least about 8 wt %, or at least about 10 wt % of the concentrate composition.

14. The composition of claim 1 wherein the composition comprises or is prepared from a firefighting foam concentrate, the concentrate comprising:
at least one anionic surfactant;
at least one amphoteric surfactant; the composition further comprising:
polyethylene glycol, and/or glycerin, and/or a sugar component, wherein:
the composition does not contain any sultaine surfactant.

15. The composition of claim 11 wherein the composition comprises or is prepared from a fluorine-free firefighting foam concentrate, the concentrate comprising:
a betaine surfactant;
a first sulfate surfactant;
a second sulfate surfactant; and
a solvent selected from the group consisting of hexylene glycol, propylene glycol, propylene glycol n-butyl ether, and combinations thereof, wherein the concentrate is free of any polysaccharide and/or biopolymer thickener.

16. The composition of claim 1 wherein the composition comprises or is prepared from a fluorine-free firefighting foam concentrate, the concentrate comprising:
a C10-C14 betaine surfactant;
a first C10-C14 sulfate surfactant;
a second C10-C14 sulfate surfactant; and
a solvent selected from glycols, glycol ethers, and combinations thereof; wherein the concentrate is free of any polysaccharide and/or biopolymer thickener.

17. The composition of claim 11 wherein the composition comprises or is prepared from a fluorine-free firefighting foam concentrate, the concentrate comprising:
a C10-C14 betaine surfactant;
a first C10-C14 sulfate surfactant;
a second C10-C14 sulfate surfactant; and
a solvent selected from glycols, glycol ethers, and combinations thereof, wherein:
the betaine surfactant is present in a concentration of from about 10 wt % to about 50 wt %, based on the total weight of the concentrate;
the first sulfate surfactant constitutes from about 2 wt % to about 25 wt %, based on the total weight of the concentrate;
the second sulfate surfactant constitutes from about 1 wt % to about 20 wt %, based on the total weight of the concentrate; and
the solvent constitutes from about 2 wt % to about 15 wt %, based on the total weight of the concentrate.

18. The composition of claim 1 wherein the composition comprises or is prepared from a fluorine-free firefighting foam composition, the composition comprising:
water;
a surfactant component comprising: (i) one or more branched chain surfactants selected from anionic surfactants, amphoteric surfactants, and combinations thereof and (ii) one or more linear chain surfactants selected from anionic surfactants, amphoteric surfactants, and combinations thereof;
a solvent component comprising one or more solvents, wherein the one or more solvents are selected from the group consisting of fatty alcohols, alcohols, glycols, glycol ethers, terpenes, and combinations thereof; wherein:
the composition is in the form of a firefighting foam concentrate having a freezing point below 2° C. (35° F.); or
the composition is in the form of a firefighting foam premix and the premix is a flowable liquid at temperatures of 0° C. or below, −10° C. or below, −20° C. or below, −30° C. or below, or −40° C. or below, and wherein:
the weight ratio of branched chain surfactants to linear chain surfactants in the surfactant component is at least about 1:1, at least about 1.5:1, at least about 2:1, at least about 2.5:1, or at least about 3:1.

19. The composition of claim 11 wherein the composition comprises or is prepared from a fluorine-free firefighting foam composition, the composition comprising:
water;
a surfactant component comprising one or more anionic surfactants, one or more amphoteric surfactants, and combinations thereof;
a solvent component comprising: (i) one or more branched chain solvents selected from the group consisting of fatty alcohols, alcohols, glycols, glycol ethers, and combinations thereof;
and (ii) one or more linear chain solvents selected from the group consisting of fatty alcohols, alcohols, glycols, glycol ethers, and combinations thereof; wherein:
the composition is in the form of a firefighting foam concentrate having a freezing point below 2° C. (35° F.); or
the composition is in the form of a firefighting foam premix that is a flowable liquid at temperatures of 0° C. or below, −10° C. or below, −20° C. or below, −30° C. or below, or −40° C. or below, and wherein:
the weight ratio of branched chain solvents to linear chain solvents in the solvent component is at least about 1:1, at least about 1.5:1, at least about 2:1, at least about 2.5:1, or at least about 3:1.

20. The composition of claim 1 wherein the composition comprises or is prepared from a fluorine-free firefighting foam composition, the composition comprising:
a surfactant component comprising one or more anionic surfactants, one or more amphoteric surfactants, and combinations thereof;
a solvent component comprising one or more solvents, wherein the one or more solvents are selected from the group consisting of fatty alcohols, alcohols, glycols, glycol ethers, terpenes, and combinations thereof; wherein:
the composition is in the form of a firefighting foam concentrate having a freezing point below 2° C. (35° F.); and/or
the composition is in the form of a firefighting foam premix that is a flowable liquid at temperatures of 0° C. or below, −10° C. or below, −20° C. or below, −30° C. or below, or −40° C. or below, and wherein:
the solvent component comprises one or more the following:
(i) one or more fatty alcohols, in a total proportion of from about 0.2 wt % to about 3.5 wt % of the solvent component, and/or
(ii) one or more alcohols, in a total proportion of from about 0.25 wt % to about 4.0 wt % of the solvent component, and/or
(iii) one or more glycols, in a total proportion of from about 5 wt % to about 30 wt % of the solvent component, and/or
(iv) one or more glycol ethers, in a total proportion of from about 2 wt % to about 20 wt % of the solvent component, and/or
(v) one or more terpenes (d-limonene) in a total proportion of from about 0.2 wt % to about 6 wt % of the solvent component.

21. The composition of claim 11 wherein the composition comprises or is prepared from a fluorine-free firefighting foam concentrate composition, the composition comprising:
water;
a surfactant component comprising one or more anionic surfactants, one or more amphoteric surfactants, and combinations thereof;
a solvent component comprising d-limonene and one or more solvents are selected from the group consisting of fatty alcohols, glycols, glycol ethers, and combinations thereof; wherein:
d-limonene constitutes from about 0.1 wt % to about 2 wt % of the foam concentrate.

22. The composition of claim 1 wherein the composition comprises or is prepared from a fluorine-free firefighting foam concentrate composition, the composition comprising:
water;
a surfactant component comprising one or more anionic surfactants, one or more amphoteric surfactants, and combinations thereof;
a solvent component comprising one or more solvents are selected from the group consisting of fatty alcohols, glycols, glycol ethers, terpenes, and combinations thereof; wherein:
anionic surfactants constitute at least about 50 wt % of the surfactant component.

23. The composition of claim 11 wherein the composition comprises or is prepared from a fluorine-free firefighting foam concentrate composition, the composition comprising:
water;
a surfactant component comprising one or more anionic surfactants, one or more amphoteric surfactants, and combinations thereof;
a solvent component comprising one or more solvents are selected from the group consisting of fatty alcohols, glycols, glycol ethers, terpenes, and combinations thereof; wherein:
the weight ratio of anionic surfactant to amphoteric surfactant in the surfactant component is from about 60:40 to about 40:60, from about 55:45 to about 45:55, or about 50:50.

24. The composition of claim 1 wherein the composition comprises or is prepared from a fluorine-free firefighting foam concentrate composition, the composition comprising:
water;
d-limonene in a proportion of from about 0.1 wt % to about 10 wt % of the concentrate;
a surfactant component comprising one or more anionic surfactants, one or more amphoteric surfactants, and combinations thereof; and
a solvent component comprising one or more solvents selected from the group consisting of fatty alcohols, glycols, glycol ethers, and combinations thereof, wherein the composition comprises:
from about 0.1 wt % to about 5 wt % of one or more alcohol or fatty alcohols;
from about 1 wt % to about 60 wt % of glycol ether solvents;
from about 25 wt % to about 60 wt % of anionic surfactants; and
from about 10 wt % to about 40 wt % amphoteric surfactants; and
wherein the composition exhibits 1% Drave Test Wetting Results of at least 8 seconds(s).

25. The composition of claim 11 wherein the composition comprises or is prepared from a fluorine-free high expansion firefighting foam, the composition comprising:
a surfactant component consisting of one or more anionic surfactants, and one or more amphoteric surfactants, wherein the anionic surfactants constitute from about 15 wt % to about 60 wt % of the composition, and the amphoteric surfactants constitute from about 20 wt % to about 50 wt % of the composition; and
the composition exhibits an expansion ratio of at least about 200, at least about 400, at least about 600, or at least about 800.

26. The composition of claim 1 wherein the composition comprises or is prepared from a fluorine-free high expansion firefighting foam, the composition comprising:
water;
d-limonene in a proportion of from about 0.1 wt % to about 3 wt % of the concentrate;
a surfactant component comprising one or more anionic surfactants, one or more amphoteric surfactants, and combinations thereof; and
a solvent component comprising one or more solvents selected from the group consisting of fatty alcohols, glycols, glycol ethers, and combinations thereof, wherein the composition comprises:
from about 0.1 wt % to about 5 wt % of one or more alcohols or fatty alcohols;
from about 1 wt % to about 60 wt % of glycol ether solvents;
from about 1 wt % to about 10 wt % of anionic surfactants; and
from about 10 wt % to about 60 wt % amphoteric surfactants; and
wherein the concentrate composition passes Vehicle system fire testing conducted at −40° C.

27. The composition of claim 11 wherein the composition comprises or is prepared from a fluorine-free firefighting foam concentrate composition, the composition comprising:
water;
d-limonene in a proportion of from about 0.1 wt % to about 3 wt % of the concentrate;
a surfactant component consisting of one or more amphoteric surfactants, and combinations thereof; and
a solvent component comprising one or more solvents selected from the group consisting of fatty alcohols, glycols, glycol ethers, and combinations thereof, wherein the composition comprises:
from about 0.1 wt % to about 5 wt % of one or more alcohols or fatty alcohols;
from about 1 wt % to about 60 wt % of glycol ether solvents; and
from about 10 wt % to about 60 wt % amphoteric surfactants; and
wherein the concentrate composition passes Vehicle system fire testing conducted at −40° C.
